(19) United States
(12) Patent Application Publication
(10) Pub. No.: US 2024/0179383 A1
(43) Pub. Date: May 30, 2024

(54) MONITORING SYSTEM

(71) Applicant: Gentex Corporation, Zeeland, MI (US)

(72) Inventors: Joshua D. Lintz, Allendale, MI (US); Benjamin N. Pohlman, Holand, MI (US)

(73) Assignee: Gentex Corporation, Zeeland, MI (US)

(21) Appl. No.: 18/520,886

(22) Filed: Nov. 28, 2023

Related U.S. Application Data
(60) Provisional application No. 63/428,816, filed on Nov. 30, 2022.

(51) Int. Cl. H04N 23/11; B60R 1/08; G02B 27/00

(52) U.S. Cl. CPC H04N 23/11; B60R 1/08; G02B 27/0093; B60R 2300/8006

(57) ABSTRACT

A monitoring system that includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source and the second exposure profile corresponds to ambient lighting.

### CROSS-REFERENCE TO RELATED APPLICATION

This application claims priority to and the benefit under 35 U.S.C. § 119(e) of U.S. Provisional Application No. 63/428,816, filed on Nov. 30, 2022, entitled “MONITORING SYSTEM,” the disclosure of which is hereby incorporated herein by reference in its entirety.

### TECHNOLOGICAL FIELD

The present disclosure relates generally to a monitoring system and, more particularly, a monitoring system that utilizes different light spectrums.

### SUMMARY OF THE DISCLOSURE

According to one aspect of the present disclosure, a monitoring system includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source, and the second exposure profile corresponds to ambient lighting.

According to another aspect of the present disclosure, a rearview mirror assembly includes a housing, a transmission element including a reflective state, and a filter configured to attenuate the transmission of one or more wavelength spectrums. A monitoring system is at least partially located in the housing. The monitoring system includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source. The second exposure profile corresponds to ambient lighting.

According to yet another aspect of the present disclosure, a rearview mirror assembly includes a housing and a display located within the housing. A monitoring system is at least partially located in the housing. The monitoring system includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source. The second exposure profile corresponds to ambient lighting.

These and other features, advantages, and objects of the present device will be further understood and appreciated by those skilled in the art upon studying the following specification, claims, and appended drawings.

### BRIEF DESCRIPTION OF THE DRAWINGS

In the drawings:

FIG. 1 is a side cross-sectional view of a monitoring system utilizing a first exposure profile according to an aspect of the present disclosure;

FIG. 2 is a side cross-sectional view of a monitoring system utilizing a second exposure profile according to an aspect of the present disclosure;

FIG. 3 is a side perspective view of an interior of a vehicle incorporating a monitoring system according to an aspect of the present disclosure;

FIG. 4A is a side cross-sectional view of a filter in a monitoring system in a first condition according to an aspect of the present disclosure;

FIG. 4B is a side cross-sectional view of a filter in a monitoring system in a second condition according to an aspect of the present disclosure;

FIG. 5 is a schematic view of a control system for a monitoring system according to an aspect of the present disclosure; and

FIG. 6 is a flow chart of a method of using a monitoring system with a first exposure profile and a second exposure profile according to an aspect of the present disclosure.

The components in the figures are not necessarily to scale, emphasis instead being placed upon illustrating the principles described herein.

### DETAILED DESCRIPTION OF EMBODIMENTS

The present illustrated embodiments reside primarily in a combination of apparatus components related to a monitoring system that utilizes different light spectrums. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

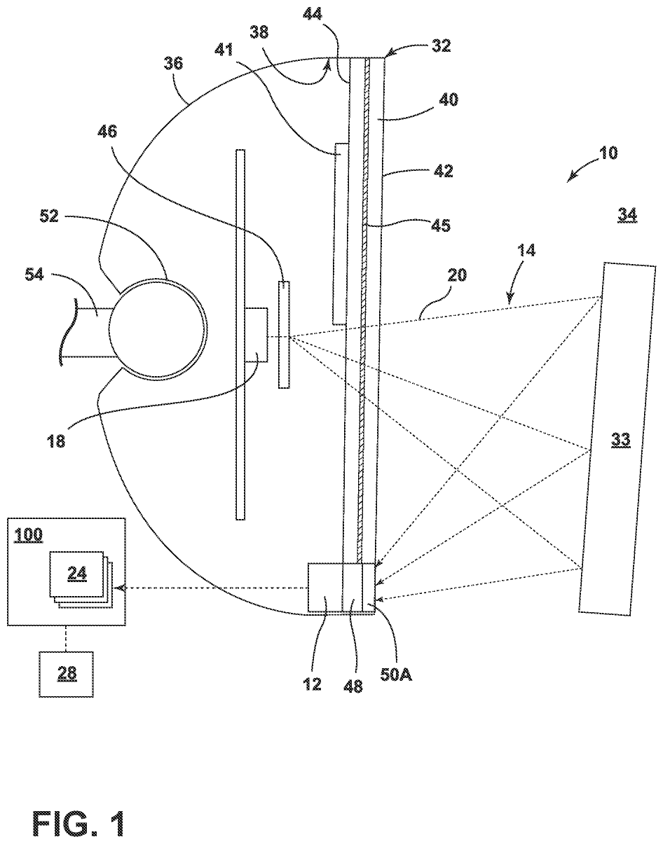

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer of the monitoring system, and the term “rear” shall refer to the surface of the element further from the intended viewer of the monitoring system. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

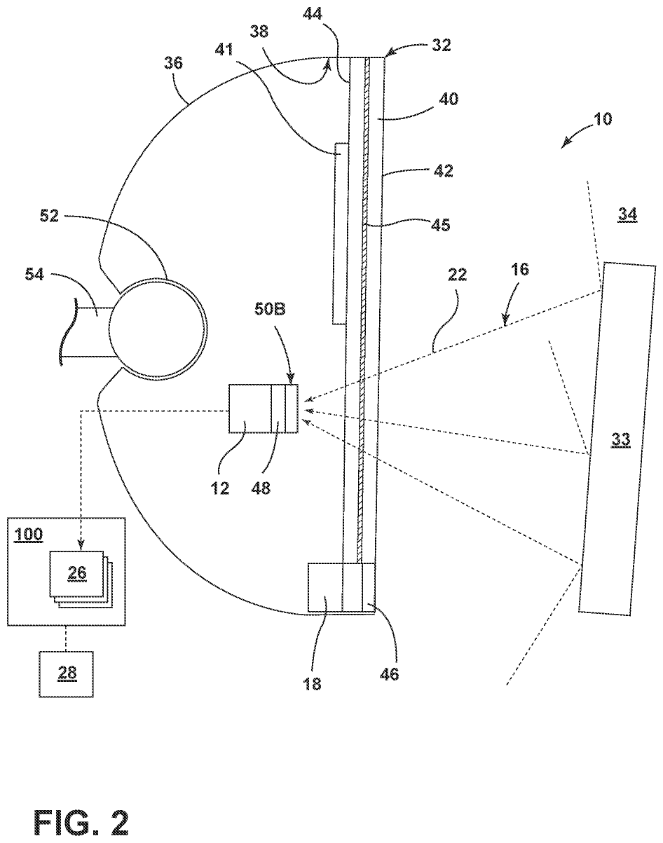

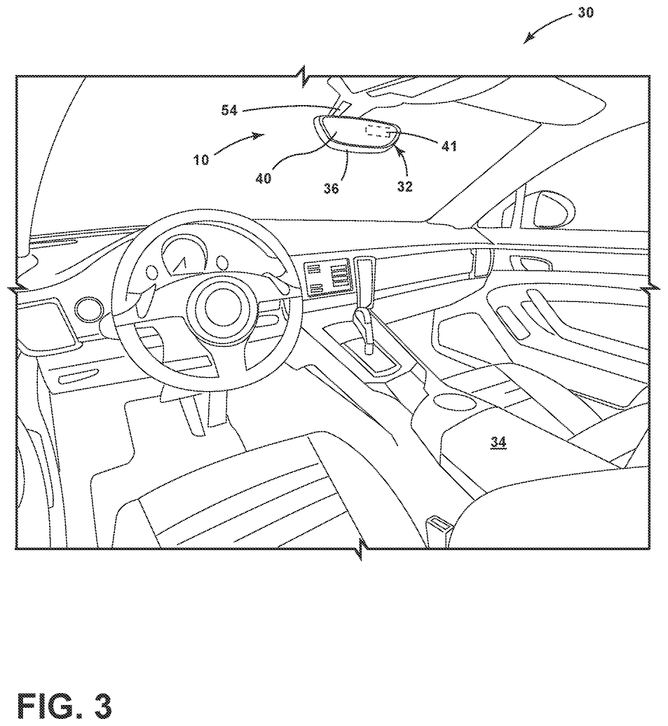

With reference to FIGS. 1-4 reference numeral 10 generally indicates a monitoring system that includes an imaging device 12. The imaging device 12 includes a first exposure profile 14 (FIG. 1) and a second exposure profile 16 (FIG. 2). An illumination source 18 is configured to emit at least one of infrared (IR) or near infrared (NIR) illumination 20. A control system 100 is configured to alternate between the first exposure profile 14 and the second exposure profile 16 in accordance with a first pattern. The first exposure profile 14 corresponds to the emission of illumination 20 from the illumination source 18, and the second exposure profile 16 corresponds to ambient lighting 22.

With reference now to FIG. 1, the first exposure profile 14 corresponds to the emission of illumination 20. In this manner, the imaging device 12 and the illumination source 18 are in sync. For example, the illumination source 18 is configured to emit the illumination 20 substantially during the first exposure profile 14 but not emit illumination 20 during the second exposure profile 16 in accordance with the first pattern (i.e., in a flashing or pulsing pattern). The first exposure profile 14 results in a first image type 24. The first exposure profile 14 includes a first exposure time that is designated for capturing the first image type 24 in the IR and/or NIR spectrum. With reference now to FIG. 2, the second exposure profile 16 corresponds to ambient lighting 22. In this manner, the imaging device 12 is configured to capture a second image type 26 with the second exposure profile 16. The second exposure profile 16 includes a second exposure time that is designated for capturing the second image type 26 substantially in a visible spectrum.

With reference to FIGS. 1 and 2, the first exposure time and the second exposure time may be different. For example, the first exposure time that operates under the principles of the IR and/or NIR spectrum may be shorter than the second exposure time that operates under the principles of the visible spectrum. More particularly, the first image type 24 includes capturing the illumination 20 that has been reflected from a target surface and, therefore, it is beneficial for the first exposure time to be short to reduce contributions from the ambient lighting 22. The second image type 26 includes a color content (e.g., pixels) such that the imaging device 12 is configured to collect light from the ambient lighting 22 to capture color content at a designated resolution and, therefore, it is beneficial for the second exposure time to be longer than the first exposure time to collect the ambient lighting 22.

The monitoring system 10 is configured to determine an intensity of the ambient lighting 22. For example, the control system 100 may be configured to detect a quality characteristic of the second image type 26 (e.g., by reviewing one or more images of the second image type 26). More particularly, the control system 100 may be configured to detect that the resolution and/or color content of the second image type 26 is below a threshold quality characteristic. In some embodiments, the monitoring system 10 includes a light sensor 28 (FIGS. 1 and 2) and the quality characteristic of the second image type 26 can be detected (e.g., by the control system 100) by communicating with the light sensor 28. For example, the light sensor 28 communicates a detected level of the ambient lighting 22 to the control system 100, and the control system 100 determines if the level of the ambient lighting 22 is below a threshold where the quality characteristic of the second image type 26 is no longer at an operational standard. Upon a determination by the control system 100 that the intensity of the ambient lighting 22 is below a threshold, the control system 100 is configured to change, alternating between the first exposure profile 14 and the second exposure profile 16, in accordance with a second pattern. The second pattern may include only the first exposure profile 14. In this manner, the rate of images of the first image type 24 captured may be greater in accordance with the second pattern. For example, in some embodiments, the rate of images of the first image type 24 captured in the second pattern may be double or greater than double the rate in the first pattern. However, in some embodiments, the rate of images of the first image type 24 captured in the second pattern may be the same as the rate in the first pattern.

With continued reference to FIGS. 1 and 2, the monitoring system 10 may be configured to review the first image type 24 in accordance with a first mode of operation, the second image type 26 in accordance with a second mode of operation, and the first image type 24 and the second image type 26, together, in a third mode of operation. In the first mode of operation, for example, the control system 100 may be configured to review the first image type 24 (e.g., or a series of images of the first image type 24) to determine mannerisms of a driver (i.e., driver monitoring), such as eye orientation, movement, and/or other mannerisms. In the second mode of operation, for example, the control system 100 may be configured to review the second image type 26 (e.g., or a series of images of the second image type 26) for the same or additional driver monitoring features (e.g., by reviewing pixel color and/or changes in color distribution) and/or to relay the second image type 26 either locally (e.g., via an onboard display 41) or remotely (e.g., with a teleconference-type application). In the third mode of operation, for example, the control system 100 may be configured to review the first image type 24 and the second image type 26, together. The first image type 24 and the second image type 26 may be reviewed together by overlaying images of the first image type 24 and images of the second image type 26 or by reviewing the first image type 24 and images of the second image type 26 at substantially the same time. In this manner, features of the first mode of operation and the second mode of operation can be used simultaneously and/or the control system 100 may be configured to enhance the accuracy of determinations based on cross-reviewing the overlapping functionalities (e.g., driver monitoring). For example, if a driver is wearing glasses that substantially blocks the IR and/or NIR illumination 20, the second mode of operation can be utilized to monitor the driver's eyes.

With reference now to FIGS. 1-3, the monitoring system 10 may be incorporated into a variety of structures, such as structures of a vehicle 30. For example, the imaging device 12 and the illumination source 18 may be connected to a rearview mirror assembly 32 for monitoring an occupant position 33 (e.g., a driver position) in a cabin 34 of the vehicle 30. The rearview mirror assembly 32 may include a housing 36 defining an opening 38 and a transmission element 40 within the opening 38. The transmission element 40 includes a front surface 42 that faces the occupant position 33 and a rear surface 44 that generally faces away from the occupant position 33. The transmission element 40 may include at least one electro-optic device 45 such that the transmission element 40 can be switched to change reflectance between a reflective state that operates as a mirror and a partially transmissive state. A display 41 may be located between the housing 36 and the transmission element 40 for displaying information to the driver (e.g., in the partially transmissive state).

The display 41 may be configured to generate information (e.g., images, graphics, messages, alerts, and/or the like) related to various conditions captured by the first and second image types 24, 26. For example, the control system 100 may be configured to extrapolate information from the first and second image types 24, 26 related to driver or occupant activity. More particularly, the control system 100 may be configured to detect unsafe driver or passenger activity like riding without a seatbelt, signs that a driver is tired (e.g., via posture or eye activity), unsafe movement around an interior of the vehicle 30, and/or the like. The display 41 (e.g., via the control system 100) may generate information related to the unsafe driver or passenger activity. The electro-optic device 45 as disclosed herein may be a single-layer, single-phase component, multi-layer component, or multi-phase component. A transmitting optical element 46 may be fixed relative to the illumination source 18 to collimate and/or diffract the illumination 20. A receiving optical element 48 may be fixed relative to the imaging device 12 to focus light therein. The housing 36 may include a connection hub 52, and the connection hub 52 may be connected to a mounting member 54. The mounting member 54 is configured to be connected to the vehicle 30 (or other environment), and the housing 36 is moveable relative to the mounting member 54 to orient the transmission element 40 at various angles relative to an occupant position 33 (or other environmental position) to obtain different environmental views and/or orientations relative to the driver. In some embodiments, the illumination source 18 is configured to generate the illumination 20 in a structured light pattern. In this manner, the control system 100 may be configured to operate under the principles of structure light such that the first image type 24 contains information that can be extracted into three-dimensional space.

With continued reference to FIGS. 1-3, the location of the imaging device 12, the illumination source 18, and the light sensor 28 can be implemented in a number of different locations. For example, FIG. 1 illustrates the imaging device 12 located outside an outer perimeter of the transmission element 40 and the illumination source 18 located within the housing 36 behind the transmission element 40. FIG. 2, alternatively, illustrates the illumination source 18 located outside an outer perimeter of the transmission element 40 and the imaging device 12 coupled to (e.g., located within or connected to an exterior) the housing 36 behind the transmission element 40. However, unless otherwise indicated, it should be appreciated that one or both of the imaging devices 12 and the illumination source 18 may be located anywhere within the vehicle 30, connected to the rearview mirror assembly 32, and located within the housing 36. In a similar manner, the light sensor 28 may be connected to the rearview mirror assembly 32 or located anywhere within or on an exterior of the vehicle 30.

With reference now to FIG. 1, a filter 50A in accordance with a first construction may be fixed relative to the imaging device 12. The filter 50A may be configured to attenuate the transmission of one or more certain wavelength spectrums. For example, the filter 50A may be configured as a static filter, for example, a dual bandpass static filter. In this manner, an IR and/or NIR non-visible spectrum utilized by the first exposure profile 14 and a visible spectrum utilized by the second exposure profile 16 can be semi-isolated by filtering other spectrums of light found in the ambient lighting 22 to enhance image quality.

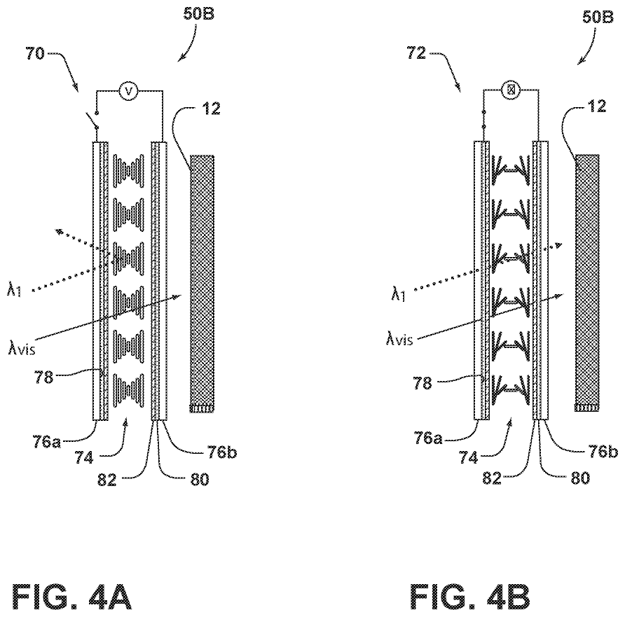

With reference to FIGS. 2, 4A and 4B, a filter 50B in accordance with a second construction may be fixed relative to the imaging device 12. The filter 50B may be configured to selectively attenuate the transmission of one or more certain wavelength spectrums. For example, the filter 50B may be configured as a dynamic filter, such as a filter incorporating a liquid crystal structure 74. The liquid crystal structure 74 may correspond to a chiral liquid crystal polymer disposed between a first substrate 76a and a second substrate 76b. The substrates 76a, 76b may correspond to glass or other substantially light-transmissive materials and may comprise one or more layers disposed on an interior surface 78 in conductive connection with the liquid crystal structure 74. The layers may correspond to a conductive layer 80 and an alignment layer 82. The conductive layer 80 may correspond to a transparent conductive layer, which may be formed of indium tin oxide or other conductive, light transmissive materials (e.g., visible, NIR, and IR spectrums as appropriate). The alignment layer 82 may be configured to adjust an alignment of the liquid crystal structure 74 in response to a voltage applied to the conductive layer 80 by the control system 100.

With reference now to FIGS. 4A and 4B, a first condition 70 may correspond to an open circuit configuration and a second condition 72 may correspond to a closed circuit configuration. In the first condition 70, the liquid crystal structure 74 may be arranged in a neutral state, wherein a helical twist structure may be formed due to an arrangement of the chiral liquid crystal polymer. The arrangement of the helical twist structure in the first condition 70 may provide for a first spectrum λ₁ (i.e., IR and/or NIR) of wavelengths of light to be reflected away from the imaging device 12 as a second spectrum Avis (i.e., at least a portion of the visible spectrum) is allowed to pass therethrough. In the second condition 72, a voltage potential may be applied across the conductive layers 80 of the first substrate 76a and the second substrate 76b. The voltage potential may cause the helical twist structure to become skewed thereby allowing the first range λ₁ of wavelengths of light to pass through the filter 50B and be received by the imaging device 12. In some embodiments, the filter 50B may include a stack (e.g., two) of liquid crystal structure 74, with a first liquid crystal structure 74 selectively transmitting or reflecting the first spectrum λ₁ and a second liquid crystal structure 74 selectively transmitting or reflecting the second spectrum λvis. In some embodiments, the present disclosure may be used with a dynamic filter such as that described in U.S. Pat. No. 10,547,783, which is hereby incorporated herein by reference in its entirety.

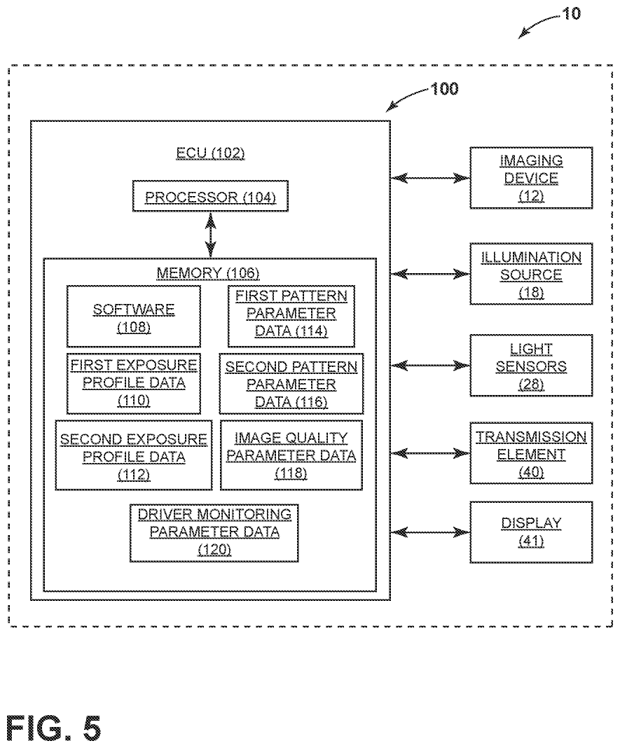

With reference now to FIG. 5, the control system 100 of the monitoring system 10 may include at least one electronic control unit (ECU) 102. In some embodiments, the at least one ECU 102 may include combinations of an ECU 102 associated with and instructing the imaging device 12, an ECU 102 associated with and instructing the illumination 18, an ECU 102 associated with and instructing the filter 50B, and/or an ECU 102 associated with and instructing the transmission element 40. In some embodiments, however, it should be appreciated that the ECU 102 is a single ECU 102 that issues global instructions to several (e.g., all or select) components of the monitoring system 10. Each ECU 102 may include a processor 104 and a memory 106. The processor 104 may include any suitable processor 104. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the monitoring system 10. The imaging device 12, the illumination source 18, the light sensor 28, the transmission element 40, and the display 41 may, therefore, be controlled by the control system 100 (e.g., the at least one ECU 102 or processors 104 associated therewith). The memory 106 may, therefore, include software 108, a first exposure profile parameter data 110, a second exposure profile parameter data 112, a first pattern parameter data 114, a second pattern parameter data 116, image quality parameter data 118, and driver monitoring parameter data 120.

It should be appreciated that while the imaging device 12 is described as including the first exposure profile 14 and a second exposure profile 16, the first exposure profile 14 and a second exposure profile 16 may be included locally or remotely via instructions from the control system 100 (e.g., the at least one ECU 102). The control system 100 may send a series of alternating instructions for each of the first exposure profile 14 and a second exposure profile 16 (e.g., every frame) or by implementing the first pattern parameter data 114 or the second pattern parameter data 116 as a single instruction. The first pattern may be based on a frame number embedded in first image type 24 and second image type 26. For example, the first image type 24 may be associated with odd numbers and the second image type 26 may be associated with even numbers. In some embodiments, the first pattern may be associated with timing. For example, the first image type 24 may be captured at a rate of timing instructed by the control system 100. In some embodiments, the first pattern may include implementing the first exposure profile 14, a second exposure profile 16, and unequal rates. For example, the first pattern may include capturing one or more images of the first image type 24 between capturing a different number of images of the second image type 26. In some embodiments, the first pattern may include capturing two or more images of the first image type 24 between capturing an equal number of images of the second image type 26.

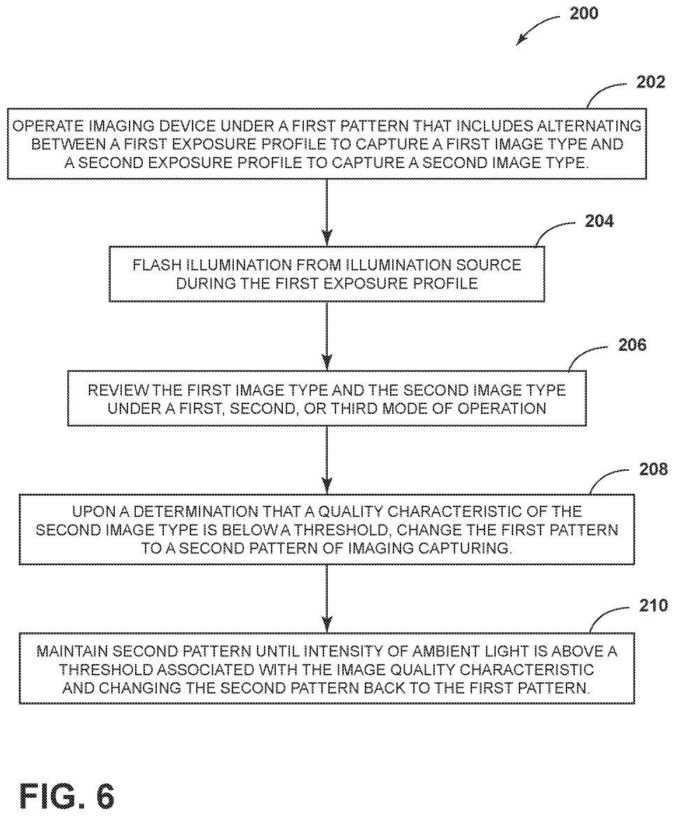

With reference now to FIG. 6, a method 200 of operating a monitoring system with at least one imaging device and at least one illumination source is provided. By reference numeral 202, the imaging device operates under a first pattern that includes alternating between a first exposure profile to capture a first image type and a second exposure profile to capture a second image type. For example, the first exposure profile may correspond to the emission of an illumination (e.g., IR or NIR) from the illumination source and the second profile may correspond to ambient lighting. An exposure time of the first exposure profile may be shorter than an exposure time associated with the second exposure profile. By reference number 204, the illumination source flashes illumination during the first exposure profile. By reference number 206, the first image type and/or the second image type are reviewed under a first, second, or third mode of operation. By reference number 206, a quality characteristic of the second image type is reviewed. For example, the quality characteristic may be reviewed within an image of the second image type or by receiving a communication from a light sensor. By reference numeral 208, upon a determination that the quality characteristic is below a threshold, changing the first pattern to a second pattern of imaging capturing. For example, upon a determination that the intensity of the ambient lighting or the quality characteristic of the second image is below a threshold, change alternating between the first exposure profile and the second exposure profile in accordance with the second pattern. In some embodiments, the second pattern may include only the first exposure profile. In some embodiments, the second pattern may include implementing a plurality of the first exposure profiles between implementation of periodic second exposure profiles. By reference number 210, the second pattern is maintained until an intensity of the ambient light is above a threshold associated with the quality characteristic, upon which the second pattern is changed to the first pattern.

The disclosure is further summarized in the following paragraphs and is further characterized by combinations of any and all of the various aspects described therein.

According to one aspect of the disclosure, a monitoring system includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source. The second exposure profile corresponds to ambient lighting.

According to another aspect, a monitoring system includes a first exposure profile that has a first exposure time and a second exposure profile has a second exposure time that is longer than the first exposure profile.

According to yet another aspect, a monitoring system includes a control system that is configured to determine an intensity of ambient lighting.

According to still another aspect, a monitoring system includes a control system that is configured to, upon a determination that the intensity of ambient lighting is below a threshold, change the imaging device to a second pattern.

According to another aspect, a monitoring system where a second pattern includes only a first exposure profile.

According to yet another aspect, a monitoring system includes a control system that is configured to maintain only a second pattern until a determination that an intensity of ambient lighting is above a threshold whereafter the control system is configured to alternate between a first exposure profile and a second exposure profile in accordance with a first pattern.

According to another aspect, a first pattern includes alternating to a first exposure profile after each second exposure profile.

According to yet another aspect, an imaging device is coupled to a rearview mirror assembly for a vehicle.

According to still another aspect, a rearview mirror assembly includes an electro-optic device defining a front surface configured to face a vehicle occupant position and a display located on a side of the electro-optic device opposite the front surface.

According to another aspect of the present disclosure, a rearview mirror assembly includes a housing, a transmission element including a reflective state, and a filter configured to attenuate the transmission of one or more wavelength spectrums. A monitoring system is at least partially located in the housing. The monitoring system includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source. The second exposure profile corresponds to ambient lighting.

According to another aspect, a filter is configured to attenuate at least one of an illumination spectrum from an illumination source or selected wavelengths from an ambient lighting outside of the illumination spectrum from the illumination source.

According to yet another aspect, a filter includes a liquid crystal structure configured to switch between a first state, wherein an illumination spectrum from an illumination source is attenuated, and a second state, wherein selected wavelengths from an ambient lighting outside of the illumination spectrum from the illumination source is attenuated.

According to still another aspect, a control system is configured to switch a filter to a first state when an imaging device is in a second exposure profile and switch the filter to a second state when the imaging device is in a first exposure profile.

According to another aspect, a liquid crystal structure includes a chiral liquid crystal polymer disposed between a first substrate and a second substrate.

According to another aspect, a control system is further configured to determine an intensity of an ambient lighting and, upon a determination that the intensity of the ambient lighting is below a threshold, change an imaging device to a second pattern that includes only a first exposure profile.

According to yet another aspect, a first pattern includes alternating to a first exposure profile after each second exposure profile.

According to yet another aspect of the present disclosure, a rearview mirror assembly includes a housing and a display located within the housing. A monitoring system is at least partially located in the housing. The monitoring system includes an imaging device. The imaging device includes a first exposure profile and a second exposure profile. An illumination source is configured to emit at least one of infrared (IR) or near infrared (NIR) illumination. A control system is configured to alternate between the first exposure profile and the second exposure profile in accordance with a first pattern. The first exposure profile corresponds to the emission of illumination from the illumination source. The second exposure profile corresponds to ambient lighting.

According to another aspect, a display is configured to generate information related to a first image type and a second image type.

According to yet another aspect, a control system is configured to detect an unsafe driver or passenger activity from a first image type and a second image type, the information generated by the display includes a notification related to the unsafe driver or passenger activity.

According to still another aspect, a filter is configured to attenuate at least one of an illumination spectrum from an illumination source or selected wavelengths from an ambient lighting outside of the illumination spectrum from the illumination source.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes, and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A monitoring system comprising:
an imaging device including a first exposure profile and a second exposure profile;
an illumination source configured to emit at least one of infrared (IR) or near infrared (NIR) illumination; and
a control system configured to alternate between the first exposure profile and the second exposure profile in accordance with a first pattern, wherein the first exposure profile corresponds to the emission of illumination from the illumination source and the second exposure profile corresponds to ambient lighting.

2. The monitoring system of claim 1, wherein the first exposure profile has a first exposure time and the second exposure profile has a second exposure time that is longer than the first exposure profile.

3. The monitoring system of claim 1, wherein the control system is further configured to determine am intensity of the ambient lighting.

4. The monitoring system of claim 3, wherein the control system is further configured to, upon a determination that the intensity of the ambient lighting is below a threshold, change the imaging device to a second pattern.

5. The monitoring system of claim 4, wherein the second pattern includes only the first exposure profile.

6. The monitoring system of claim 5, wherein the control system is further configured to maintain only the second pattern until a determination that the intensity of the ambient lighting is above a threshold, wherein the control system is configured to alternate between the first exposure profile and the second exposure profile in accordance with the first pattern.

7. The monitoring system of claim 1, wherein the first pattern includes alternating to the first exposure profile after each of the second exposure profiles.

8. The monitoring system of claim 1, wherein the imaging device is coupled to a rearview mirror assembly for a vehicle.

9. The monitoring system of claim 8, wherein the rearview mirror assembly includes an electro-optic device defining a front surface configured to face a vehicle occupant position and a display located on a side of the electro-optic device opposite the front surface.

10. A rearview mirror assembly comprising:
a housing;
a transmission element including a reflective state;
a filter configured to attenuate a transmission of one or more wavelength spectrums; and
a monitoring system at least partially located in the housing and comprising:
an imaging device aligned with the filter and including a first exposure profile and a second exposure profile;
an illumination source configured to emit at least one of infrared (IR) or near infrared (NIR) illumination; and
a control system configured to alternate between the first exposure profile and the second exposure profile in accordance with a first pattern, wherein the first exposure profile corresponds to the emission of illumination from the illumination source and the second exposure profile corresponds to ambient lighting.

11. The rearview mirror assembly of claim 10, wherein the filter is configured to attenuate at least one of an illumination spectrum from the illumination source or selected wavelengths from the ambient lighting outside of the illumination spectrum from the illumination source.

12. The rearview mirror assembly of claim 10, wherein the filter includes a liquid crystal structure configured to switch between a first state, wherein an illumination spectrum from the illumination source is attenuated, and a second state, wherein selected wavelengths from the ambient lighting outside of the illumination spectrum from the illumination source is attenuated.

13. The rearview mirror assembly of claim 12, wherein the control system is further configured to switch the filter to the first state when the imaging device is in the second exposure profile and switch the filter to the second state when the imaging device is in the first exposure profile.

14. The rearview mirror assembly of claim 13, wherein the liquid crystal structure includes a chiral liquid crystal polymer disposed between a first substrate and a second substrate.

15. The rearview mirror assembly of claim 13, wherein the control system is further configured to determine an intensity of the ambient lighting and, upon a determination that the intensity of the ambient lighting is below a threshold, change the imaging device to a second pattern that includes only the first exposure profile.

16. The rearview mirror assembly of claim 10, wherein the first pattern includes alternating to the first exposure profile after each of the second exposure profiles.

17. A rearview mirror assembly comprising:
a housing;
a display located within the housing; and
a monitoring system at least partially located in the housing and comprising:
an imaging device including a first exposure profile for generating a first image type and a second exposure profile for generating a second image type;
an illumination source configured to emit at least one of infrared (IR) or near infrared (NIR) illumination; and
a control system configured to alternate between the first exposure profile and the second exposure profile in accordance with a first pattern, wherein the first exposure profile corresponds to the emission of illumination from the illumination source and the second exposure profile corresponds to ambient lighting.

18. The rearview mirror assembly of claim 17, wherein the display is configured to generate information related to the first image type and the second image type.

19. The rearview mirror assembly of claim 18, wherein the control system is further configured to detect an unsafe driver or passenger activity from the first image type and the second image type, and wherein the information generated by the display includes a notification related to the unsafe driver or passenger activity.

20. The rearview mirror assembly of claim 19, further including a filter configured to attenuate at least one of an illumination spectrum from the illumination source or selected wavelengths from the ambient lighting outside of the illumination spectrum from the illumination source.
